(19) United States
(12) Patent Application Publication
(10) Pub. No.: US 2010/0030675 A1
(43) Pub. Date: Feb. 4, 2010

(54) Payor focused business to business electronic invoice presentment and accounts payable reconciliation system and method

(76) Inventors: Christopher C. Hanan, Chicago, IL (US); Bukkapatnam Rama Mohan, Naperville, IL (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/310,983

(22) Filed: Dec. 6, 2002

Related U.S. Application Data
(60) Provisional application No. 60/336,131, filed on Dec. 6, 2001.

(51) Int. Cl. G06Q 30/00; G06Q 10/00; G06Q 20/00

(52) U.S. Cl. 705/34

(57) ABSTRACT

The present invention provides a system that creates a secure image of an invoice accessible to the payors and their billers through the web. Users have the option of viewing the invoice and adjudicating any disputes prior to payment. Once a payment decision has been made, payors can generate one stream of output from their enterprise resource program (ERP) systems to make payments to all of their vendors irrespective of the mode of payment. Payments will be made to all billers based on their existing preferences and the billers do not have to change their processes at all. The payments and issues file will be returned to the payors to complete posting to their accounts payables. The system provides data-feeds to all payors and billers to pre-reconcile their A/P and A/R systems.

### CROSS REFERENCE TO RELATED APPLICATIONS

The present invention claims priority to U.S. Provisional Application No. 60/336,131 filed Dec. 6, 2001, the contents of which are incorporated herein by reference in their entirety.

### FIELD OF THE INVENTION

The present invention relates to a method and system for presentment and reconciliation of electronic invoices.

### BACKGROUND OF THE INVENTION

Electronic invoice payment and presentment (EIPP) systems have become widespread, but suffer from various deficiencies. First, most prior systems are biller-centric. Prior systems typically create value for the biller as the result of adoption by his/her customers. Some prior systems are inconvenient for the customers or payors, because they require the payors to modify their disbursement practices. Accordingly, it is difficult to convince payors to adopt such systems.

Furthermore the implementation cost and complexity of some existing EIPP systems is often prohibitive. Initial “hub” installation is relatively complex and may require significant hardware, software and system integration investment by billers.

Additionally, existing models of some EIPP systems make network effects difficult to achieve. Most systems follow a biller-centric model. In the biller-centric model, it is difficult to entice payors. It has also been difficult to get cross-fertilization to drive network effects. The large number of data-formats in existing systems makes consolidation much more difficult.

An additional problem with some existing EIPP systems is lack of integration. There has been no integration into internal workflow and no integration with existing disbursement systems.

Security concerns with the usage of the Internet for funds disbursement and data-security have presented a further barrier for some existing systems. Lack of consolidation in a biller-driven market drives payor concern around multi-system environments. Other security concerns including, but not limited to, appropriate levels of control, access control, data-security, data-ownership, and viability of providers also exist.

Furthermore, the complexities involved in getting a sufficient number of counter-parties registered have deterred development of electronic invoice payment and presentment systems. Specifically, legal and risk considerations are associated with adding large numbers of users (specifically payors). Additionally, the registration process is typically cumbersome. A significant amount of information is required (e.g., bank account numbers, tax IDs, etc.). These complexities are sufficient to deter independent billers with insufficient sale-support and banks unaccustomed to deploying high-complexity solutions in large number.

Furthermore, some existing EIPP solutions merely replace existing payment mechanisms and do not leverage existing bank infrastructure and lockbox processes. To date, existing EIPP systems have not been able to co-exist with traditional processes and instead tend to displace traditional processes entirely thereby avoiding the traditional pitfalls of network dependencies. Other drawbacks also exist. Accordingly, a system is needed that will maximize adoption by leveraging a bank's position, processes, existing infrastructure, investments, and customer base. Thus, electronic payment systems must be re-designed for bank-driven deployment. Furthermore, it would be advantageous to develop a system that minimizes network dependencies since network dependencies are one key reason for low adoption levels and long implementation times. It would also be an advantage if the system leverages and complements existing products.

Another advantage would be to create a solution that can bring immediate value to customers without any changes to existing business processes by leveraging a bank's lockbox relationships and processing capabilities and integrating the data-flows from the biller's invoices and the bank's lockbox operations.

Another drawback of existing systems is that they do not provide a convenient and efficient way for payors to consolidate invoices from multiple channels. For example, a payor may receive invoices from multiple billers (e.g., a vendor, a service provider, etc.), each having particular payment requirements (e.g., checks only, wire transfer, etc.) and a different payment address. Among other things, this is inconvenient because the payor must ensure that each invoice receives the correct payment (e.g., correct type of payment, to correct address, etc.).

Another drawback of typical existing systems is that they do not provide a payment directory of predetermined biller payment preferences. The lack of a registry of biller preferences often means that the biller must provide this information to each payor or that each payor must determine the information.

Another drawback of typical existing systems is that they do not easily integrate with existing payables processes provided by banks and other financial institutions. For example, some banks may provide payables processes which enable bank customers to outsource the generation of payments (e.g., electronic and paper payments) with a single input to the bank. Typically, these bank systems do not easily integrate with most payor based payment systems.

### BRIEF SUMMARY OF THE INVENTION

The present invention overcomes these and other drawbacks of existing systems by providing a system and method for payor focused business to business electronic invoice presentment and accounts payable reconciliation.

An embodiment of the invention creates a secure image of an invoice accessible to payors and billers through the Internet or other computer-based network. One advantage of the invention is that users (e.g., billers and payors) have the option of viewing an invoice and resolving any disputes prior to payment. Once a payment decision has been made, payors can generate one stream of output from their enterprise resource program (ERP) systems to make payments to all of their vendors and other billers irrespective of the mode of payment. Payments may be made to billers based on their existing preferences and the billers may change their accounts receivable (A/R) processes relatively little, if at all. The payments and issues file may be returned to the payors to complete posting to their accounts payables (A/P). The system provides data-feeds to payors and billers to pre-reconcile their A/P and A/R systems.

An embodiment of the system integrates electronic invoice presentment with a sponsoring host's (e.g., a bank, other financial institution, other host, etc.) imaging, electronic payments, check outsourcing and account reconciliation applications to bring immediate value to users without waiting for mass adoption. The system may additionally remove the need to implement electronic payment solutions, eliminate changes to payors disbursement processes, pre-reconcile invoices with payments and eliminate changes to billers reconciliation processes. Embodiments of the system may further eliminate exception processing by capturing all invoices settled and all payments made at as few as two integration points.

Embodiments of the system may capture payor invoices and their payment status from a payor's ERP systems and present them electronically. Billers and payors can resolve the disputes online and billers can pre-reconcile their A/R systems with the changes. Billers may maintain their payment preferences in a central repository which will be used to initiate payments. Payors may create one output stream of all payments and their effective dates to pay all of their invoices.

Another advantage of the invention is that it may be deployed as a shared service for all users. A host (e.g., a bank, other financial institution, or other host) may periodically upgrade the implementation with necessary enhancements. On the payor's side, the system enhances efficiency of invoice settlement and cash disbursement and reconciliation processes.

In some embodiments, a host (e.g., a sponsoring bank, other financial institution, or other host) may deliver unique services and immediate value to payors by integrating invoice presentment and payment application with existing disbursement systems, accounts reconciliation systems and ERP systems.

Accordingly, an embodiment of the payor hub of the invention may capture and deliver paper and electronic invoices in a single electronic input stream (e.g., by functioning as a reverse lockbox). In addition, embodiments of the invention may capture and store scheduled payments with full details, allow control over payment mode and timing, provide a collaborative platform to settle disputes, create global registry of customers and processing instructions, and integrate with ERP systems to post payments.

Another embodiment of the invention provides a system and method for payors to consolidate invoices received from multiple sources (e.g., more than one biller) and in multiple formats (e.g., electronic, paper, etc.). According to some embodiments, the payor may set up a reverse lockbox arrangement with a bank or other financial institution. The payor may then either direct billers to send invoices to the lockbox (e.g., electronically or on paper) or upload or otherwise deliver the invoices to the lockbox. At the lockbox, information from the various invoices may be consolidated and fed to the payors A/P systems. In addition, the payor may issue payment orders to the lockbox and pay multiple billers from this single source.

Another embodiment of the invention provides a system and method for billers to set up a registry of payment preferences. For example, a biller may register with a payor hub by providing information relating to payment preferences (e.g., payment address, payment type (e.g., check, ACH, wire, etc.), payment due date, etc.). The payors may then access the registry and schedule payments accordingly. In some embodiments, payments may automatically be carried out according to information in the biller's registry (e.g., payor issues an authorization to pay and lockbox administrator carries out payment according to biller's registry information).

Another embodiment of the invention provides a system and method for integrating a payor hub system with existing bank (or other financial institutions) payables processes. For example, Bank One provides a Pay$tream payables system which allows payors to outsource the generation of both electronic and paper payments with a single input (e.g., data transmission) to the bank. Other payables systems are possible. In some embodiments, the payables process is integrated into the payor hub system to enable the payor to further consolidate A/P processes. Other features and advantages also exist.

### BRIEF DESCRIPTION OF THE DRAWINGS

The present invention can be understood more completely by reading the following Detailed Description Of Exemplary Embodiments, in conjunction with the accompanying drawings.

FIG. 1 is a schematic of an overall system according to an embodiment of the invention.

FIG. 2 is a flow chart illustrating biller hub process flow according to an embodiment of the invention.

FIG. 3 is a flow chart illustrating payor hub process flow according to an embodiment of the invention.

FIG. 4 is a block diagram illustrating an embodiment of the system of the invention.

FIG. 5 is a schematic illustration of a payor hub system according to embodiments of the invention.

### DETAILED DESCRIPTION OF EXEMPLARY EMBODIMENTS

For purposes of illustration, a system and method according to exemplary embodiments of the present invention are described herein.

The above-identified figures and the following description provide an overview of a biller hub implementation and a payor hub implementation of an electronic invoice presentment and reconciliation invention. The invention may rely on industry-standard software components for some basic processing functions. The process solution may be implemented in software, firmware or other computer readable formats and deployed in secure operational site or other locations.

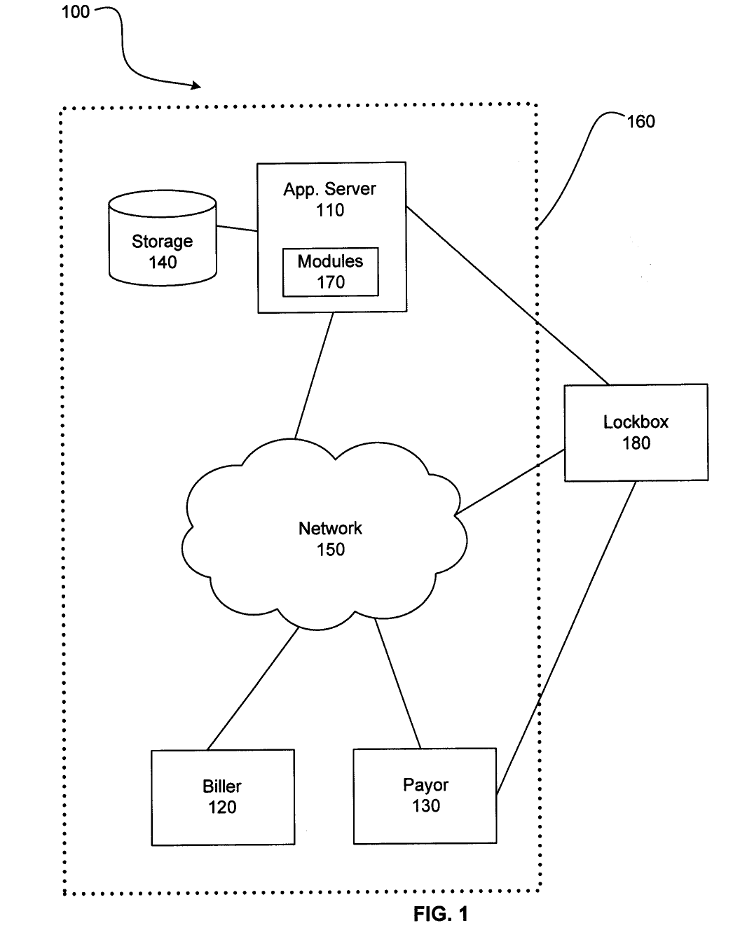

According to an embodiment of the invention, various components of system 100 (e.g., biller 120, payor 130, etc.) may be separate entities such as individuals, corporations or limited liability companies. Other embodiments, in compliance with applicable laws and regulations, may also be used. In addition, it is to be understood that biller 120, payor 130 and other various entities described herein may employ a computer to implement the components performing the herein described functions. As shown in FIG. 1, system 100 may comprise one or more computer-based components (e.g., application server 110, biller 120, payor 130, etc.). Although, only one of each is shown, any number of computer-based components may be used. According to an embodiment of the invention, a computer may be a standard computer comprising an input device, an output device, a processor device, and data storage device. According to other embodiments of the invention, various components may be different department computers within the same corporation or entity. Other computer configurations may also be used.

The computer-based components of the invention (e.g., 110, 120, 130, etc.) may comprise any known types of computer (e.g., PC, Mac, server, workstation, laptop, personal digital assistant (PDA), etc.). The computer components may operate using any-of a variety of operating programs, such as a Microsoft Windows 98,™ Windows 2000,™ Windows XP,™ Linux, Macintosh OS, or other operating system.

The system 100 may also comprise a plurality of storage devices 140 which may include any suitable storage device, such as a database, hard drive, a CD-ROM, or an optical disc, etc. Other storage devices 140 and configurations are also possible.

The system 100 may also enable communication between billers 120, payors 130 and other system components by using a communication interface to other computers via a network 150. The network 150 may comprise the Internet, an intranet, a Personal Area Network (PAN), a Local Area Network (LAN), a Wide Area Network (WAN), a Metropolitan Area Network (MAN), or another similar type of network. The network 150 may alternatively use wireless technology to connect a plurality of computers together. The network 150 can operate using any network-enabled code, such as a Hyper Text Markup Language (HTML), a Dynamic HTML, an Extensible Markup Language (XML), an Extensible Stylesheet Language (XSL), a Document Style Semantics and Specification Language (DSSSL), a Java language, etc.

A biller hub 160 may comprise a biller 120, payors 130 application server 110 and the associated application modules 170. Application modules 170 are understood to be computer readable code (e.g., software, firmware, etc.) that enables the various computer-based system components to carry out the functions described herein. While shown residing on application server 110, it is also to be understood that application modules 170 may be distributed throughout system 100 (i.e., various modules or parts of modules may reside at biller 120, payor 130, etc.), on more than one server, or in some other suitable configuration.

To participate in a biller hub 160, a host (e.g., a sponsoring bank) may invite billers and payors to participate in the system 100. The system may require very little if any process changes for the billers and payors and will operate in an almost transparent manner.

Payors 130 may register company details, account details and their billers 120 (e.g., regular vendors, service providers, etc.) in a central registry (e.g., storage 140) maintained by the host (e.g., a sponsoring bank). The host (e.g., sponsoring bank) may invite the stored billers 120 (e.g., vendors, etc) to participate. Billers 120 may also register themselves and their payors 130 in the service to view and download the payment information.

Payors 130 may continue their current business practices and use their legacy systems to create, manage and schedule payment for invoices. In some embodiments, payors 130 may outsource invoice capture to a host (e.g., a sponsoring bank, etc.) via a reverse lockbox 180. The host may have the infrastructure required to convert paper invoices into electronic format invoices from billers 120. Both paper and electronic invoices may then be delivered to the billers 120 and payors 130 in a customizable format.

Payors 130 may also continue their current practices to reconcile invoices, approve invoices and make payment decisions. If disputes arise, payor 130 may use the online collaborative features to settle the disputes with the billers 120. On a regular or other basis, payors 130 may upload a payment file containing a authorized payments and invoice updates to the payor hub service.

In some embodiments, the payment information and invoice updates will be immediately available online to billers 120. Billers 120 may view and download the payment information to pre-reconcile their ERP systems and speed up posting of cash. Also, billers 120 may actively participate in online dispute resolution process.

In some embodiments, system 100 may monitor scheduled payments and initiate payments on the scheduled day from payor's 130 account. The payor 130 need not be concerned about printing and mailing checks or keeping different processes for different payment methods.

In some embodiments, system 100 may route all payments through a payment system such as Pay $tream, provided by Bank One, or some other payment system proprietary to the host, sponsoring bank, etc., to route payments using the correct medium (e.g., automated clearing house (ACH), Wire, Check, etc.).

Though system 100 expects to handle most payments electronically, paper checks may be printed and mailed to the billers 120 who are not capable of receiving electronic payments. For example, a host's or other sponsoring bank's check outsourcing product may provides paper check features.

In some embodiments, where payments may be issued from a single application, payors 130 may also take advantage of the host's or sponsoring bank's positive pay services to validate the checks presented for clearing before releasing payments. This may reduce the amounts lost due to fraudulent activities.

After the payments are made, system 100 may be updated with the confirmation numbers and payment issues. The information may be downloaded to update payor's 130 and biller's 120 accounting systems.

In some embodiments, system 100 may maintain the invoices and payments online with the audit history for a pre-specified time. Such archiving, may be useful in case of disputes arising after payments are made, for trouble shooting of payments sent tracking changes to invoices, or other reasons.

The system 100 may be valuable to the payor 130 for a variety of reasons. For example, the payor 130 may receive all of its invoices in electronic format by utilizing reverse lockbox 180 services. In addition, all invoices may be delivered electronically in payor's 130 preferred format. This reduces the need to push the billers 120 to adopt electronic invoice presentment. It also reduces the need to handle multiple streams of invoices and reduces the time required to enter invoices into ERP systems. The payors 130 may also view the invoices and settle any disputes online. Additionally, payors 130 may download the invoice details in CSV, XML, or other suitable format to upload into their ERP systems. In some embodiments, the download format can be customized for any payor 130.

Embodiments of system 100 also enables payors 130 to upload a payments file, in a standard or custom format, using a Web-based interface. In some embodiments, the format is flexible and may handle almost any detail level of data to be sent with payment. There is little or no need to change any of payor's 130 internal processes.

Embodiments of system 100 also enables payor 130 to schedule payments ahead of the effective day by any number of days. The payments schedule information may be safely stored (e.g., in storage 140) and payments can be executed on schedule avoiding all uncertainties of printing and sending checks.

In some embodiments, the billers 120 or other receiving parties may have access to the payment schedule. This may reduce inquiries from billers 120 or other vendors about the status of invoice and payment discrepancies. Also, the amounts may be posted to the payor 130 faster, as the biller 120 can use the payment information to reconcile it's A/R systems.

In embodiments where the payments and the supporting invoice details are visible to both payor 130 and biller 120, a collaborative platform for settling disputes is enabled. For example, both parties may add additional data, unformatted text, or other information to the payment or invoice to resolve discrepancies.

The payor 130 may eliminate the cost of printing, handling and reconciling checks. In cases where the biller 120 or other the receiving party cannot receive electronic payments, the host or sponsoring bank may print and mail checks to the biller 120 as described above.

Through system 100, payors 130 may be freed from maintaining the payment information about thousands of parties with which they interact. The payment information of each biller 120 may be updated and kept current by the biller 120, host or some other central administrator. The payor 130 can assume the information in the registry is the latest and correct. Such reliability reduces problems involved in sending the checks to wrong addresses and associated delays.

In some embodiments, payments may be verified against biller's 120 payment instructions at the time payments are scheduled. The payments that cannot be handled may be returned well ahead of time giving sufficient time for rectification.

In some embodiments, payors 130 can use system 100 without waiting for any of their billers 120 or other counter parties to register. For example, payors 130 may send the information about billers 120 or other counter parties to the host or other system administrator. The data may be maintained by the host or other system administrator until the biller 120 registers with the system or some other process (e.g., mailing a paper check) occurs.

System 100 may also be valuable to the biller 120. For example, the biller 120 may register with a host or other registration authority and set up the information required to receive payments. Once the information is set up, this information may be available to payors 130. Updating the information will be relatively easy as the change needs to be done only once and payors 130 get the latest payment information.

In some embodiments, billers 120 may view some or all payments they are scheduled to receive and, thus, significantly affect their ability to manage working capital. Billers 120 may also drill down through the payments into further levels of details and see the payments for individual invoices.

As discussed above, if discrepancies exist, the biller 120 may raise alerts to the payors 130 well in advance and attempt to settle the dispute. In some embodiments, biller 120 may add disputed fields to the invoice and payment. These changes may be notified to the payors 130. Resolving discrepancies earlier may reduce errors in posting cash when payments are received.

In some embodiments, billers 120 may chose to receive paper checks or electronic payments. When payment is made, the electronic instructions may also contain post-back information that allows fully automated handling. The data associated with payment may identify whether the invoice is paid in full, as per agreement, or the amount paid is still to be resolved.

In some embodiments, to simplify posting of cash, billers 120 may download invoice modification details and pre-reconcile their A/R systems. This reduces costs associated with exception processing.

In some embodiments, system 100 may also be valuable to the host or sponsoring bank. For example, the host or sponsoring bank may build and operate a biller 120 directory that provides up-to-date payment instructions to the payors 130. In addition, the host or sponsoring bank may set up an initial registry with the current lockbox 180 customers to give immediate value to the payors 130. This information may also be used to provide other financial services.

By capturing payments in electronic form, the host or sponsoring bank avoids some of the expenses of handling paper checks and invoices. The payment instructions may be converted into electronic format right at the source. In addition, the host or sponsoring bank may get additional revenue opportunities like reverse lockbox 180, invoice presentment, EDI transmission of invoices, reconciling payment, invoice data and other opportunities.

The host or sponsoring bank may also sell the services to the billers 120 as enhanced lockbox 180 that offers global payment directory services, validation of payment transactions at authorization (ahead of actual payment date), integrated A/R for posting receipts, and other features.

In some embodiments, system 100 may be further enhanced to capture the invoices from an A/R module and send them to the A/P module of the participating payors 130. All invoices rejected by payor 130 may be tagged and reported as exceptions. The payments from payors 130 may be reconciled with original invoices and exceptions can be notified to billers 120 for immediate action.

As described herein, system 100 is capable of performing some or all of the following functions: registration of billers 120 and payors 130, capture of payment and invoice files from A/P modules, posting of payment and invoice details on the Web, providing online collaboration features, initiation of payment on schedule date, directory updates to payment instructions, downloading of files for posting cash to A/R and other functions.

In summary, the system provides both a biller and payor hub. Both leverage a host's or sponsoring bank's position, processes, existing infrastructure investments and customer base. The models have to provide value to the hub without spoke involvement. The system 100 may be designed for deployment by a host or sponsoring bank. Furthermore, the system 100 removes many network dependencies, which are a frequent reason for low adoption levels and long implementation times of other systems. The system 100 leverages a sponsoring bank's control and capability of controlling the hub customer activities. The system 100 leverages and complements existing products, uses logical building blocks and leverages existing customers. The hub 160 creates process efficiencies and supply chain management tools and leverages the sponsoring bank's automated clearinghouse (ACH) expertise. Other advantages exist.

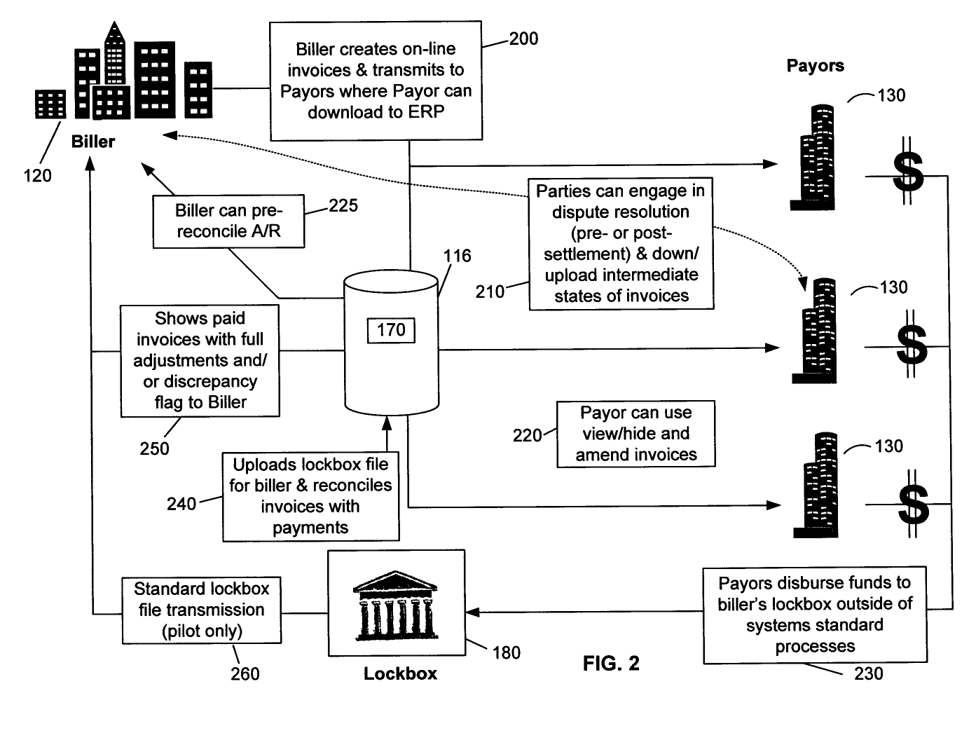

FIG. 2 is a schematic representation of a biller hub 160 process flow according to embodiments of the invention. As shown, a process may initiate, as indicated at 200, when a biller 120 creates an on-line invoice or invoices and transmits (e.g., via network 150) them to the payors 130. The payors 130 may then download or otherwise view the invoices. As indicated at 210, biller 120 and payors 130 may engage in dispute resolution (e.g., on-line) or other intermediate steps and download or otherwise access updated invoices. At 220 payors may continue to view and amend invoices as desired. At 225 biller 120 may pre-reconcile A/R systems based, at least in part, on the accessed invoice information. As indicated at 230, payors disburse funds to biller's 120 lockbox 180 (e.g., using standard processes). As indicated at 240, lockbox 180 information may be uploaded and integrated with invoice information (e.g., via one or more modules 170 on server 110). At 250, biller's 120 A/R systems may be updated (e.g., via one or more modules 170 on server 110). In some embodiments, biller 120 may also receive standard lockbox 180 data transmissions as indicated at 260.

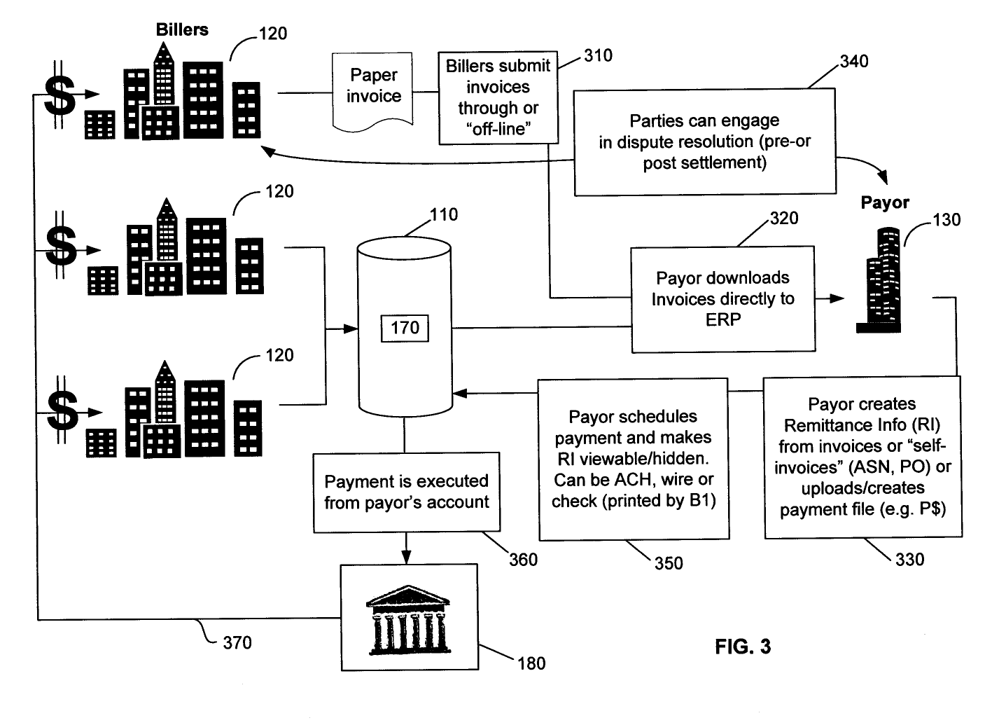

FIG. 3 is a schematic representation of a payor hub process flow according to embodiments of the invention. As indicated at 310, a biller 120 may issue a paper invoice or, as indicated at 315, a biller 120 may issue an electronic invoice. At 320, payor 130 may download or otherwise view the invoices. In some embodiments, payor 130 may create remittance information as indicated at 330. Billers 120 and payor 130 may engage in dispute resolution (e.g., online) as indicated at 340. At 350, payor 130 may schedule payment (e.g., via one or more modules 170 on server 110). At 360 payment may be executed from payor's 130 account (e.g., via one or more modules 170 on server 110) to lockbox 180. In some embodiments, biller 120 and payor 130 may engage in dispute resolution (e.g., as indicated at 340) after payment is executed. As indicated at 370 payment may be delivered to billers 120 via usual lockbox 180 procedures.

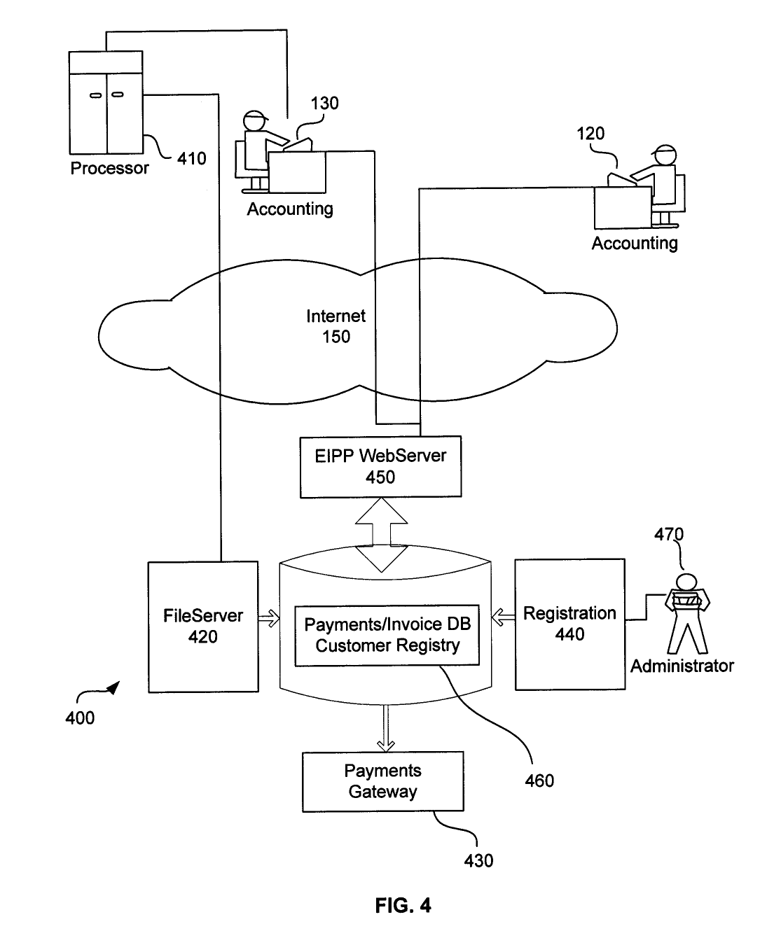

FIG. 4 is a schematic illustration of a payor hub 400 according to embodiments of the invention. As shown, this embodiment implements multiple servers to accomplish the herein described functions and features of the invention. For example, the above described functions of application server 110 and modules 170 may be distributed over processor 410, file server 420, payments gateway 430, registration module 440, EIPP web server 450 and other servers. As also shown in FIG. 4, storage 140 may, in some embodiments, comprise a payments/invoice database and customer registry 460.

In some embodiments, customer registry 460 may comprise information relating to biller 120 preferences. An administrator 470 (e.g., a bank or other financial institution) may administrate the customer registry 460. Other configurations are also possible.

In embodiments of the invention, lockbox 180, when operated from a payor's 130 perspective, may enable a payor 130 to consolidate invoices from multiple channels. For example, payor 130 may set up a reverse-lockbox (e.g., lockbox 180) arrangement with a bank, other financial institution, or other host in order to collect and compile information relating to biller 120 invoices. Payor 130 may instruct lockbox 180 to collect invoices (e.g., via mail or EIPP systems), upload invoices themselves (e.g., by file transfer) or other wise deliver invoices to lockbox 180. In embodiments of the invention, lockbox 180 may then (e.g., at payor's 130 instruction) issue payments to the various billers 120. Lockbox 180 may also interface with payor's 130 existing A/P systems to enable reconciliation processes.

As noted above with respect to FIG. 4, embodiments of the invention may comprise a payments gateway 430 that interfaces with other bank payables processes. For example, payments gateway 430 may interface with a payables process such as Pay$tream, provided by Bank One. In this manner, date collected by a payor hub may be fed into the Pay$tream or other payables process to facilitate check or other payment issuing. Other embodiments are also possible.

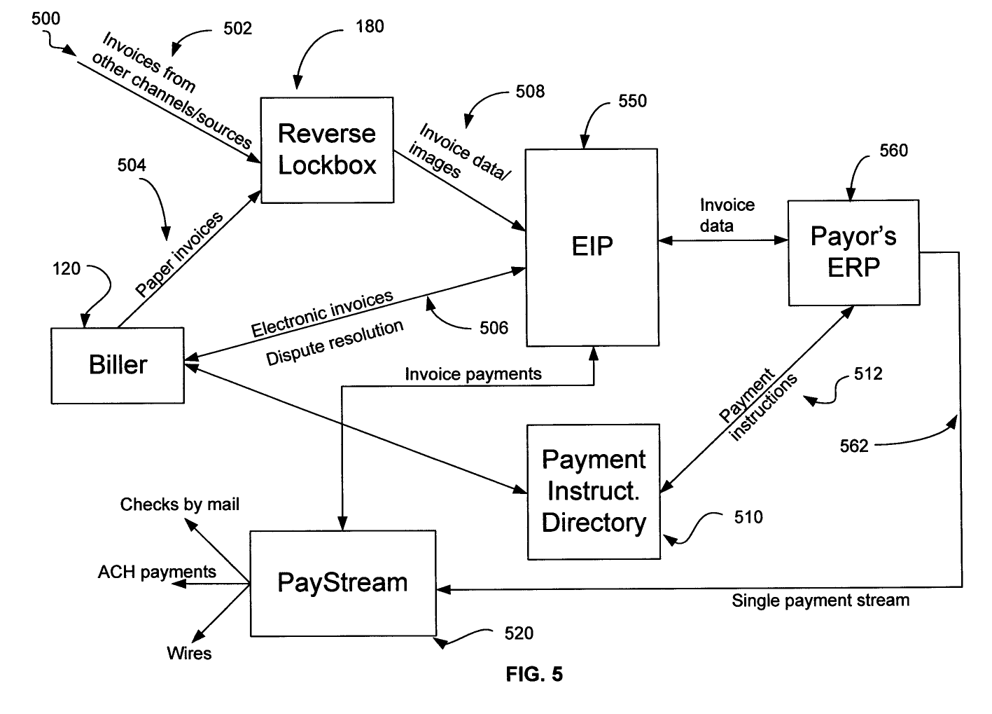

FIG. 5 is a schematic illustration of a payor hub system 500 according to embodiments of the invention. In general, system 500 illustrates a scenario where multiple type of invoices may be received and processed into a single payment stream. As indicated, invoices may be received from numerous sources. For example, biller 120 may issue paper invoices as indicated at 504, electronic invoices as indicated at 506 and invoices may originate from other sources as indicated at 502. Some of the invoices (e.g., paper invoices 504, other invoices 502, etc.) may be processed in reverse lockbox 180. In some embodiments processing of paper and other invoices may comprise reading the information from the invoices and converting that information into invoice data and images as indicated at 508.

In some embodiments the invoice data may be communicated to an electronic invoice presentment (EIP) module 550 (e.g., a module 170 executed by application server 110). Electronic invoices 506 may be communicated (e.g., over network 150) into EIP module 550. Embodiments of the invention also enable dispute resolution to be conducted via EIP module 550.

Payor 130 may communicate with EIP module 550 as described above. In addition, EIP module 550 may communicate with payor's 130 ERP 560 to enable, for example, reconciliation processes.

Payor 130 may also receive (e.g., at ERP 560) biller 120 payment instructions. For example, biller 120 may communicate payment preferences, billing addresses, etc. which may be stored (e.g., in storage 140) and implemented as a payment instruction directory 510 as described above.

Payor's 130 EPR 560 may combine the various invoice information, and payment instructions 512 to generate a single payment stream 562 which may include authorization orders to pay certain invoices, certain amounts at specified times, from specified accounts, as well as other information. As shown in FIG. 5, payment stream 562 may communicate with payables processes (e.g., PayStream 520). PaySteam 520, or other payables process, may enable payments to be made to biller 120 via paper checks, ACH payments, wire transfer or other acceptable mechanisms.

Additional advantages features and modifications will readily occur to those skilled in the art. Therefore, the invention is not limited to the specific details in the representative embodiments shown and described above. Accordingly, various modifications may be made without departing from the spirit and scope of the general inventive concept as defined by the appended claims.

1. (canceled)

2. A computer based method for implementing a biller registry, the computer based method comprising the steps of:
enabling, by a computer processor, a biller to input payment preference information at an interface wherein the payment preference information comprises a combination of payment address, payment type, and payment due date;
storing, by the computer processor, the payment preference information in a database; and
enabling, by the computer processor, a payor to access the payment preference information through a user interface;
wherein the payor creates one or more payor schedules for one or more payments based at least in part on the payment preference information, wherein the biller accesses the one or more payor schedules for the one or more payments and wherein the biller reconciles one or more accounts receivable systems using the one or more payor schedules; and
wherein the one or more payments are authorized by the payor and automatically processed by a lockbox administrator based at least in part on the payment preference information;
wherein the computer processor is linked to a computer based network.

3. (canceled)

4. A computer based system for implementing a biller registry, the computer based system comprising:
an input interface for enabling a biller to input payment preference information, wherein the payment preference information comprises a combination of payment address, payment type, and payment due date;
a database for storing the payment preference information; and
a payor access module for enabling a payor to access the payment preference information in the biller registry;
wherein the payor creates one or more payor schedules for one or more payments based at least in part on the payment preference information, wherein the biller accesses the one or more payor schedules for the one or more payments and wherein the biller reconciles one or more accounts receivable systems using the one or more payor schedules; and
wherein the one or more payments are authorized by the payor and automatically processed by a lockbox administrator based at least in part on the payment preference information.

5.-17. (canceled)
